(19) United States
(12) Patent Application Publication
(10) Pub. No.: US 2003/0167991 A1
(43) Pub. Date: Sep. 11, 2003

(54) Motorized surfboard and method of assisting surfer in paddling out to waves

(76) Inventor: Stan Namanny, Hermosa Beach, CA (US)

Correspondence Address: CISLO & THOMAS, LLP, 233 WILSHIRE BLVD, SUITE 900, SANTA MONICA, CA, 90401-1211, US

(21) Appl. No.: 10/093,783

(22) Filed: Mar. 6, 2002

(51) Int. Cl. B63B 1/00; B60L 15/20; B63B 35/73

(52) U.S. Cl. 114/55.56; 440/7; 441/74

(57) ABSTRACT

A kit for converting a conventional surfboard into a motorized one, to assist a surfer in paddling away from shore, includes a small motor attachable to the surfboard and a control remote. The electric motor is built directly into a rudder or fin, attachable to the surfboard without any structural modification to the board. The remote control is wireless and worn on the surfer's hand or wrist. With a motorized surfboard propelling the surfer forward at a low rate of speed, it is unnecessary for the surfer to exert considerable energy paddling out to catch another wave.

### BACKGROUND OF THE INVENTION

1. Field of the Invention

This invention pertains generally to a motorized surfboard to assist a surfer in paddling out from shore to catch and ride a wave of water, and more particularly to such a device having a motor being radio controlled by the surfer.

2. Description of the Related Art

The history of surfing goes back centuries. Initially surfboards were generally over ten (10) feet long and heavy, made of wood that tended to soak up water. Sometime around World War II rudders were added to the underside of surfboards which helped make them more maneuverable. Certain individuals began doing more radical board maneuvers, and surfing became a fad of the 1950s.

In the later half of the twentieth century surfing became a sport of increased popularity, especially in heavily-populated southern California and Hawaii, especially on the north shore of Oahu where waves tend to be very large. Improvements in surfboard design included introduction of foam and fiberglass materials made for boards that were lighter weight and also easier to manufacture than those carved of wood decades earlier. The new boards were much more maneuverable on the water as well.

The late 1960s saw the introduction of the shortboard, having a length of about six (6) feet, and also use of a flexible rudder or fin which allowed boards to move faster and turn tighter. In the 70s and 80s multiple fins were introduced, as well as “stick-on” fins which could be mounted in various positions outside the permanently glassed-on central fin. The leash or leg rope connecting surfers to surfboards was also invented.

In recent years certain refinements were made to the shape and contour of the surfboard, but in general major innovations have been few. Most surfers have been generally satisfied with the improved equipment as it is. One problem is that surfers who began the sport in the 1960s and still surf today, however, are getting much older. Repeatedly paddling out from shore to catch and ride another wave is becoming more difficult as these surfers age and their physical capabilities decline.

### OBJECTS OF THE INVENTION

Accordingly, it is an object of the present invention to provide a simple device attachable to a conventional surfboard to assist surfers, especially those of limited physical ability, in paddling out away from shore.

It is another object that the device of the present invention weigh as little as possible and be streamlined and as small as possible to avoid interfering with normal operation of the surfboard in catching and riding waves back into shore.

It is yet another object that attachment of the device require no structural modification of the conventional surfboard.

Finally, an additional object of the present invention is that it be set up for ease of control, and that the surfer need not reach around to a motor mounted on the underside of the board to start or stop propelling of the board forward.

These and other objects and advantages of the present invention will be apparent from a review of the following description and accompanying drawings.

### SUMMARY OF THE INVENTION

A kit for converting a conventional surfboard into a motorized surfboard to assist a human surfer in paddling out from shore to catch and ride a wave of water includes a motor attachable to an underside of the conventional surfboard without structural modification to the surfboard. The motor has enough power to push the surfer along in the water at about five (5) miles per hour, and is preferably battery powered. Preferably there is a streamlined housing in which the motor is mounted, and a propeller coupled to the motor and preferably mounted inside a protective cowling. Preferably the housing is integral to the central rudder or fin, or it could be attachable to the rudder or fin adjacent the underside of the surfboard.

A controller remote from the motor, but preferably in wireless communication with the motor, allows the surfer to signal operation of the motor. Preferably the controller may vary the output of the motor to propel the surfer on the motorized surfboard from zero to its maximum speed. Preferably the controller is attachable to the surfer's body and is battery powered.

Operation of the invention is envisioned as follows. A motor having a maximum output of approximately two horsepower is procured. The motor is attached to the underside of the surfboard without making any structural modifications to the surfboard. Preferably this is by attaching a fin having a streamlined housing containing the motor. The surfboard is placed in the water near the shore. The surfer climbs atop the surfboard. The motor is turned on to propel the surfboard forward, such that it is unnecessary for the surfer to exert considerable energy paddling out away from the shore. Preferably the motor is remotely controlled from the surfer's body, and the turning-on of the motor is by sending a wireless signal.

### BRIEF DESCRIPTION OF THE DRAWINGS

FIG. 1 is a perspective drawing of the preferred embodiment showing components of the kit;

FIG. 2 is a perspective view showing the components installed on the underside of a conventional surfboard;

FIG. 3 is a block diagram of the components of the preferred embodiment;

FIG. 4 is a cross-sectional view of a fin with integral housing containing the motor;

FIG. 5 is a perspective view of the fin housing the motor;

FIG. 6 is a perspective view of a wireless remote control; and,

FIG. 7 is a perspective view of an alternate wireless remote control.

### LISTING OF REFERENCE NUMERALS

kit . . . 10

battery charger . . . 15

rudder or fin . . . 20

integral housing . . . 22

forward nose cap . . . 23

electric motor . . . 24

motor compartment cap . . . 25

propeller . . . 26

protective cowling . . . 27

forward bulkhead . . . 28

aft bulkhead . . . 29

conventional surfboard . . . 30

slot (for rudder) . . . 31

motorized surfboard . . . 40

wireless remote control . . . 50

power supply (remote) . . . 52

batteries (remote) . . . 53

speed control (remote) . . . 54

transmitter . . . 56

receiver . . . 58

power supply (motor) . . . 60

watch-type batteries (motor) . . . 61

speed control (motor) . . . 62

hand wrap . . . 70

speed control wheel . . . 72

battery compartment . . . 74

battery cap . . . 76

wrist band . . . 80

power switch . . . 82

### DESCRIPTION OF THE PREFERRED EMBODIMENT

The detailed description set forth below in connection with the appended drawings is intended as a description of the presently-preferred embodiment of the invention, and is not intended to represent the only forms in which the present invention may be constructed and/or utilized. The description sets forth the structure and the sequence of steps for constructing and operating the invention in connection with the illustrated embodiments. It is to be understood, however, that the same or equivalent structures and sequences may be accomplished by different embodiments that are also intended to be encompassed within the spirit and scope of the invention.

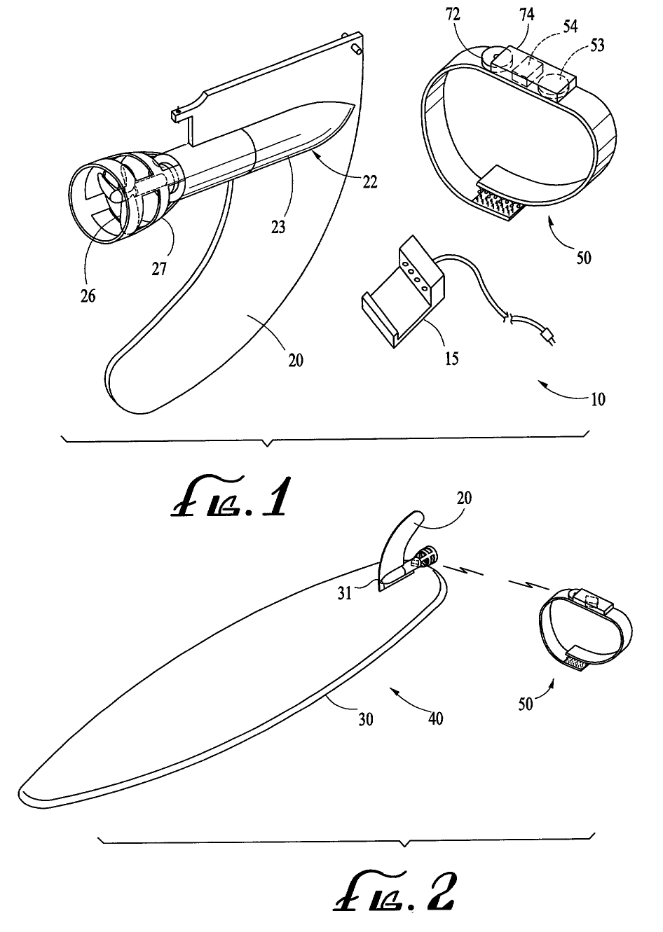

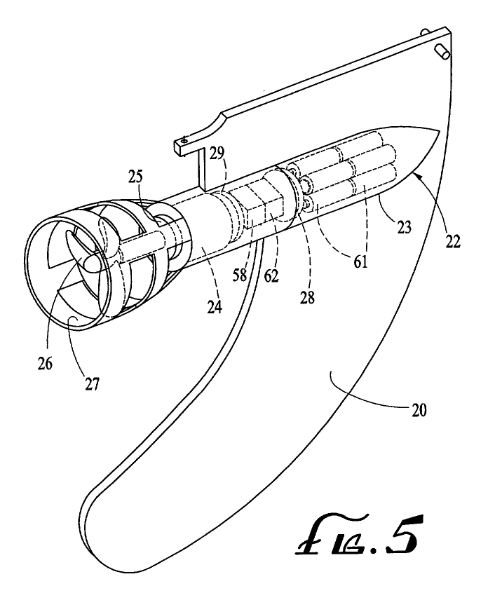

Referring to FIGS. 1 and 5, illustrated is the kit 10 of the preferred embodiment of the present invention to convert a conventional surfboard 30 into a motorized surfboard 40 to assist a surfer in paddling out from shore. The kit 10 includes a rudder or fin 20 having an integral housing 22 containing an electric motor 24, the rudder or fin 20 attachable to the conventional surfboard 30. The kit 10 further includes a wireless remote control 50 attachable to the body of the surfer, preferably either to his or her hand or wrist. Finally, the kit 10 may contain a conventional battery charger 15 for conventional batteries 61 of the electric motor 24.

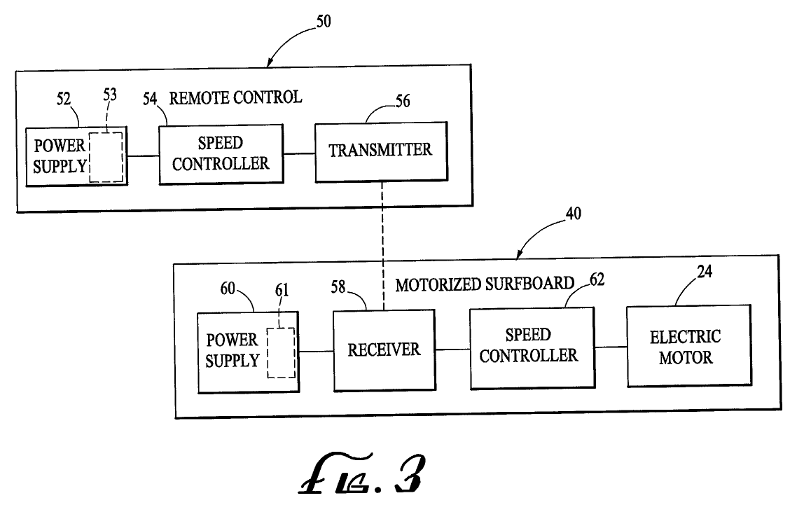

FIG. 2 illustrates attachment of the rudder or fin 20 to the conventional surfboard 30 to make the motorized surfboard 40. The attachment is accomplished without any structural modification of the conventional surfboard 30. Such conventional surfboards 30 typically have a slot 31 sized to receive the rudder or fin 20, and the aft end of the rudder or fin 20 includes a set screw (not shown), hand tightened to securely hold the rudder or fin 20 in the conventional surfboard 30.

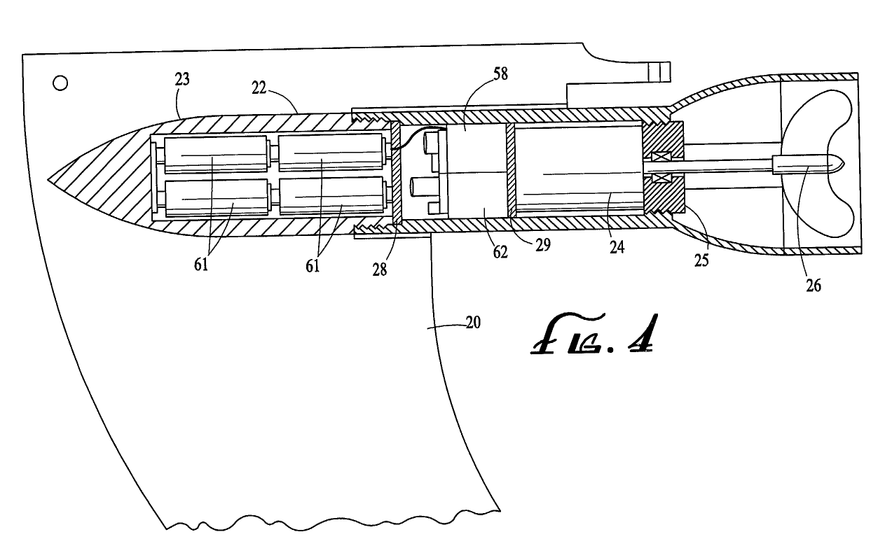

Referring to FIG. 3, illustrated are the basic electrical components of the preferred embodiment. The remote control 50 includes a power supply 52, in electrical communication with a speed control 54 and a transmitter 56. The power supply 52 is preferably a watch-type battery 53, as the remote control 50 need only have very short range capability, perhaps ten feet or less.

In wireless communication with the remote control 50 transmitter 56 is a receiver 58 contained in the integral housing 22 of the attachable rudder or fin 20. In electrical communication with the receiver 58 are a power supply 60, an electronic speed control 62 and the electric motor 24. The speed control 62 is an integrated circuit that regulates the power based on signals received from the receiver 58, from the power supply 60 to the motor 24.

Parts of the transmitter 56 and receiver 58 are antennae (not shown) for transmitting and receiving the radio waves for wireless communication. The receiver 58 antenna may consist of a wire that plugs into and dangles off the back of the rudder or fin 20 housing 22, with a float on the end to keep a portion of the antenna on top of the water. Alternatively, the receiver 58 antenna wire could wrap around to the top surface of the surfboard and be attached thereto with one or more small strips of Velcro®.

FIGS. 4 and 5 illustrate the hardware inside the integral housing 22 of the attachable rudder or fin 20. Contained therein are eight (8) rechargeable Ni—Cd (nickel cadmium) 1.5 volt batteries 61, the receiver 58, the speed control 62 and the electric motor 24. Coupled to the electric motor 24 is a propeller 26 which provides a thrusting force to drive the surfboard forward. The propeller 26 has three 60 millimeter blades and a 5 millimeter shaft.

There are many different types and sizes of motors available, either with brushes or brushless. An appropriate brushless motor 24 would be intended for direct drive of the propeller 26 to approximately 20,000 revolutions per minute. The batteries 61 directly affect the duration of power as well as the thrust of the motor 24. Higher powered batteries at 4.8, 6.0, 7.2 and 9.6 volts are readily available.

Between the motor 24 and propeller 26 is a threaded motor compartment cap 25 that puts a watertight seal around the motor 24, keeping water from going in the small opening in the housing 22 for the propeller shaft. The threaded motor compartment cap 25 also helps to dissipate heat into the surrounding water. Between the receiver 58 and speed control 62 on the one hand, and the motor 24 and batteries 61 on the other hands, are forward and aft bulkheads 28 and 29, respectively, merely keeping the compartments housing these components separate from one another.

The forward nose of the integral housing 22 is a threaded cap 23 having a watertight seal to the remainder of the housing 22. Surrounding the propeller 26 is a protective cowling 27 to safeguard against inadvertent contact by the surfer with the propeller 26. The cowling 27 is a cage-like structure keeping the surfer's hands away from the propeller 26 while allowing free flow of water through.

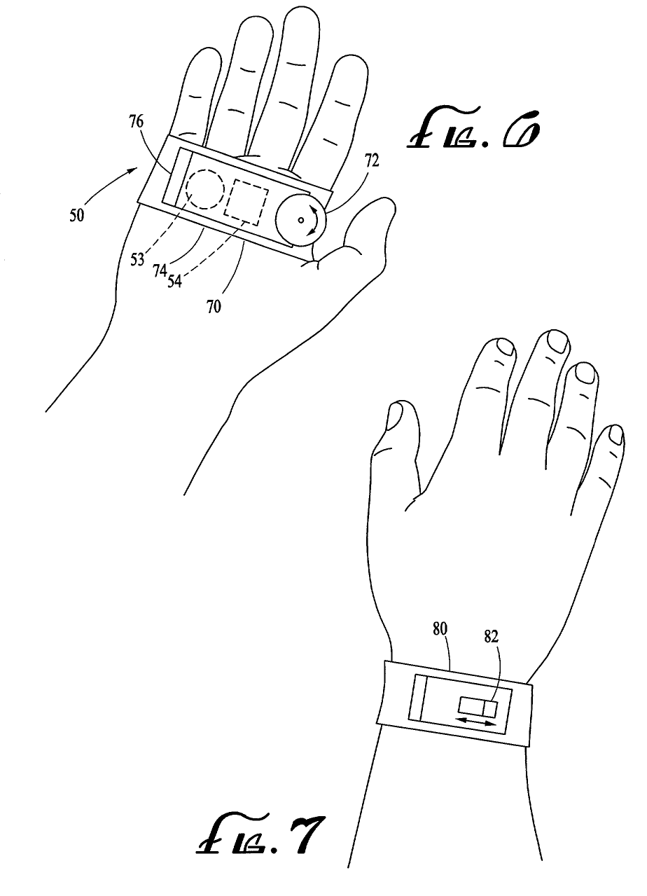

FIG. 6 shows a possible embodiment for the wireless remote control 50, a hand wrap 70 with a speed control wheel 72 and a battery compartment 74 and watertight battery cap 76. Rotating the wheel 72 to the right causes the speed of the motor 24 to increase, whereas rotating it in the opposite direction causes it to slow down or stop.

Having described the structure of the preferred embodiment of the kit 10 and motorized surfboard 40, it is now possible to describe their operation and use. The attachable rudder or fin 20 having the integral housing 22 containing the electric motor 24 is procured, along with the eight pack of 1.5 volt Ni—Cd rechargeable batteries 61.

Additionally, the other major part of the kit 10 or motorized surfboard 40 is procured, the wireless remote control 50 consisting of the partial glove 70 and speed control wheel 72 along with a watch-type battery 53. The batteries 61, 53 are loaded into the rudder or fin 20 housing 24 and wireless remote control 50 battery compartment 74, and the caps 23, 76 replaced to make the housing 22 and battery compartment 74 watertight.

Next the rudder or fin 20 housing 22 may be attached to a conventional surfboard 30, by sliding it into the slot 31 found in most conventional surfboards 30 and tightening the attachment means. The now-motorized surfboard 40 may be placed in the water near shore, and the surfer may climb aboard to paddle out to larger waves.

Then the electric motor 24 may be turned on to propel the motorized surfboard 40 forward. This is accomplished by using the wireless remote control 50 to send a signal to the motor 24 to drive the propeller 26. The surfer triggers the motor 24 by turning the speed control wheel 72. This causes electrical contacts to touch completing a circuit connected to a specific pin of the speed control 54 integrated circuit. The completed circuit causes the remote control transmitter 56 to send out a sequence of electrical pulses. There is preferably a synchronization segment that alerts the receiver 58 to the incoming information, and a pulse segment that conveys the information to the antenna in the receiver 58. Within the pulse segment are pulse sequences that provide directions to turn the motor 24 on and control its speed.

The transmitter 56 sends out bursts of radio waves that oscillate at an assigned frequency for this type of device, known as pulse modulation. The AM or FM receiver 58 is monitoring for a signal, that upon being received is converted back into an electrical pulse sequence. The pulse sequence is sent to the electronic speed control 62 integrated circuit. This integrated circuit sends current from the power supply 60 to the motor 24 to make it operate at the appropriate speed. The motor 24 shaft may contain gears on the end of it, rather than connecting directly to the propeller 26 shaft, decreasing the speed but increasing the torque of the propeller 26 giving it an adequate output to operate.

The motorized surfboard 40 as described herein should provide several hours of intermittent operation being recharging of the battery 61, and perhaps about one hour of continuous operation per battery charge. The wireless remote control 50 should provide many hours of operation between battery changings. Both the motorized surfboard 40 and wireless remote control 50 have external on/off switches (not shown) that control their power supply.

While the present invention has been described with regards to particular embodiments, it is recognized that additional variations of the present invention may be devised without departing from the inventive concept. By way of example only, although the preferred embodiment illustrates a kit 10 or conversion of a conventional surfboard 30, alternatively it could instead be configured with a permanently mounted rudder or fin 20 containing the motor 24. Although the preferred embodiment has a rudder or fin 20 with integral housing 22 containing the motor 24, instead it could be a separate housing containing the motor 24 attachable to a conventional rudder or fin, or the underside of a conventional surfboard. Although shown as having a wireless remote control 50, the remote control could instead be a wired remote control, connected to the motorized surfboard 40 by a wire. The wireless remote control hand wrap 70 with speed control wheel 72 shown could be replaced by a wireless remote control wrist band 80 (FIG. 7) with a simple on/off switch 82 for controlling the motor 24. The motorized surfboard 40 could easily offer the capability to operate in reverse as well as the forward direction. Although steering is typically accomplished by the surfer leaning to one side of the board or the other, the motorized surfboard 40 could offer wireless steering on a second channel of radio communications, accomplished through a pivotal connection of the motor 24 or some other means. More than one rudder or fin 20 housing a motor 24 could also be attached to a conventional surfboard 30. Lastly, the receiver 58 antenna could be permanently built into the laminated materials of which conventional surfboards 30 typically are constructed. These are just a few examples of numerous other possible variations of the present invention.

What is claimed is:

1. A kit for converting a conventional surfboard into a motorized surfboard to assist a human surfer in paddling out from shore to catch and ride a wave of water comprising:
a motor attachable to an underside of the conventional surfboard without structural modification to the conventional surfboard;
the motor having a maximum output to propel the surfer on the motorized surfboard at approximately 5 miles per hour; and,
a controller remote from the motor for the surfer to signal operation of the motor.

2. The kit of claim 1 wherein the controller is in wireless communication with the motor.

3. The kit of claim 1 wherein the controller may vary the output of the motor to propel the surfer on the motorized surfboard from zero to approximately five miles per hour.

4. The kit of claim 1 wherein the controller is attachable to the surfer's body.

5. The kit of claim 1 wherein the motor is battery powered.

6. The kit of claim 5 further comprising a battery to power the motor.

7. The kit of claim 2 wherein the controller is battery powered.

8. The kit of claim 7 further comprising a battery to power the controller.

9. The kit of claim 1 further comprising a streamlined housing containing the motor.

10. The kit of claim 1 further comprising at least one propeller coupled to the motor.

11. The kit of claim 10 further comprising a cowling in which the at least one propeller is mounted.

12. The kit of claim 1 wherein the maximum output of the motor is approximately four horsepower.

13. The kit of claim 1 further comprising a fin attachable to the underside of the surfboard.

14. The kit of claim 13 further comprising a streamlined housing integral the fin and containing the motor.

15. A motorized surfboard to assist a human surfer in paddling out from shore to catch and ride a wave of water comprising:
a conventional surfboard having a top side for the surfer to ride upon and having an underside;
a motor attachable to the underside of the surfboard without structural modification of the surfboard;
the motor having a maximum output to propel the surfer at approximately five miles per hour; and,
a controller in wireless communication with the motor for the surfer to signal operation of the motor.

16. The motorized surfboard of claim 15 further comprising a fin attachable to the underside of the surfboard and having a streamlined housing integral the fin containing the motor.

17. A method of assisting a human surfer paddling away from shore on a conventional surfboard to catch and ride a wave of water comprising the steps of:
procuring a motor having a maximum output of approximately two horsepower;
attaching the motor to the underside of the surfboard without making any structural modifications to the surfboard;
placing the surfboard in the water near the shore;
the surfer climbing atop the surfboard; and
turning on the motor to propel the surfboard forward;
whereby it is unnecessary for the surfer to exert considerable energy paddling out from the shore.

18. The method of claim 17 further comprising the step of attaching a remote controller of the motor to the surfer's body.

19. The method of claim 17 wherein the turning-on is by sending a wireless signal to the motor.

20. The method of claim 17 wherein the step of attaching the motor is by attaching a fin having an integral streamlined housing containing the motor.
